(19) United States
(12) Patent Application Publication
(10) Pub. No.: US 2001/0033787 A1
(43) Pub. Date: Oct. 25, 2001

(54) Gravity auto-latch system

(76) Inventor: David Eekhoff, Litchfield, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/780,088

(22) Filed: Feb. 9, 2001

Related U.S. Application Data
(60) Provisional application No. 60/186,641, filed on Mar. 3, 2000.
(60) Provisional application No. 60/181,865, filed on Feb. 11, 2000.

(51) Int. Cl. B60P 1/00; B23P 17/00

(52) U.S. Cl. 414/537; 296/61; 29/700; 29/592

(57) ABSTRACT

An auto latch system for use with a transport vehicle having a rotatable ramp shiftable between a transport disposition and a load disposition, includes a latch assembly operably coupled to a transport vehicle bed. A ramp engagement assembly is operably coupled to the ramp. The latch assembly automatically engages the ramp engagement assembly during shifting of the ramp from the load disposition to the transport disposition.

CROSS-REFERENCE TO RELATED APPLICATIONS

This application claims priority under 35 U.S.C. §119 (e) to, and hereby incorporates by reference, U.S. Provisional Application No. 60/186,641, filed Mar. 3, 2000 and U.S. Provisional Application No. 60/181,865 filed, Feb. 11, 2000.

### BACKGROUND OF THE INVENTION

1. Field of the Invention

The present invention relates to transport vehicles, such as trailers. More particularly, the present invention relates to transport vehicles having rotatable loading ramps coupled to the rear of the transport vehicle.

2. Description of Related Art

Transport vehicles with rotatable ramps are known. The loading ramps are rotatable between a generally upright transport disposition and a loading disposition in which the ramps extend from the rear of the transport vehicle to the ground. In the transport disposition, the ramps are typically held in the upright position by pins inserted through bores defined in fixed vehicle brackets and a bore defined in the ramp that is brought into registry with the bores in the vehicle brackets. While such means of locking the ramps in the transport disposition are adequate, they present some difficulty in insertion of the pins. The ramps typically are quite heavy and must be maneuvered with one hand to bring the bore defined in the bracket and the bore defined in the ramp into alignment for insertion of the pin with the second hand. Additionally, the pins have been known to become detached and lost.

In view of the foregoing, there is a need in the industry for a latching system to automatically engage when the ramp is rotated into its upright, transport disposition without manual intervention. Further the latching system should be readily disengageable for rotation of the ramps from the transport disposition to the loading disposition.

### SUMMARY OF THE INVENTION

The ramp auto latch system of the present invention substantially meets the aforementioned needs of the industry. The auto latch system is permanently affixed to the transport vehicle to prevent loss. The auto latch system automatically engages when the ramp is maneuvered into its upright, transport disposition. No manual intervention is required in order to effect engagement of the auto latch system with the ramp. This frees up both hands of the operator for maneuvering the ramp into the transport disposition. Further, the gravity auto latch system of the present invention is readily disengageable with one hand prior to rotation of the ramp from the transport disposition to the load disposition.

The present invention is an auto latch system for use with a transport vehicle having a rotatable ramp shiftable between a transport disposition and a load disposition. The auto latch system includes a latch assembly and a ramp engagement assembly. The latch assembly is operably coupled to a transport vehicle bed. The ramp engagement assembly is operably coupled to the ramp. The latch assembly automatically engages the ramp engagement assembly when the ramp is shifted from the load disposition to the transport disposition.

### BRIEF DESCRIPTION OF THE DRAWINGS

FIG. 1 is an exploded, perspective view of the auto latch system of the present invention in relation to the transport vehicle and the transport vehicle ramp, the transport vehicle ramp being in the transport disposition;

FIG. 2 is an assembled, perspective view of the auto latch system of FIG. 1; and

FIG. 3 is a side elevational view of the latch assembly thereof.

### DETAILED DESCRIPTION OF THE DRAWINGS

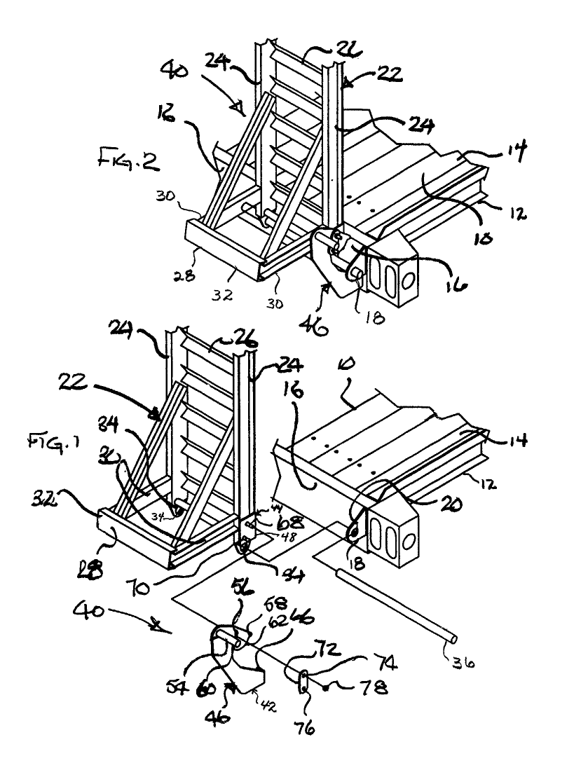

The ramp auto latch system of the present invention is designed to be utilized with a transport vehicle, such as a trailer. The right rear portion of the vehicle with the ramp which is rotatably couplable thereto is depicted in FIGS. 1 and 2. It is understood that typically, the left rear portion of the transport vehicle would have a similar mirror image configuration and ramp. The vehicle bed 10 includes a frame 12, the frame 12 supporting decking 14. The decking 14 may be formed of wooden planks affixed to the frame 12. The frame 12 includes a rear tail board 16, that extends widthwise across the rear of the vehicle bed 10. A pair of spaced apart brackets 18 are fixedly coupled to the rear tail board 16 and extend rearward therefrom. Each of the brackets 18 has an eye 20 defined therein.

A ramp 22 is rotatably coupled to the rear of the vehicle bed 10. The ramp 22 has a pair of spaced apart side rails 24, which may be generally parallel. A plurality of cross ties 26 extend between the side rails 24 for supporting the wheels of a vehicle being loaded onto the vehicle bed.

A support member 28 extends generally orthogonally, or otherwise transversely, with respect to the side rails 24. In this embodiment, the support member 28 has a pair of sides 30 affixed to respective side rails 24. A cross support 32 may extend between the distal ends of the sides 30. An eye 34 may be defined proximate an end of each of the side rails 24 of the ramp 22. In order to couple the ramp 22 to the vehicle bed 10, the eyes 34 are brought into registry with the eyes 20 and the ramp 22 is rotatably coupled to the vehicle bed 10, e.g., by means of a rod hinge 36 passed through the eyes 20, 34.

The ramp 22 is shiftable between a generally upright transport disposition as depicted in FIGS. 1 and 2 and a load disposition in which the ramp 22 is rotated downwardly so that the distal end (not shown) of the ramp 22 engages the ground. In this disposition, the ramp 22 is essentially a slightly depending extension of the upper surface of decking 14. The support member 28 extends downwardly from the rear of the vehicle bed 10 in a position in which the cross support 32 is in close proximity to a portion of the ground surface underlying the rear of the vehicle bed 10. As a heavy vehicle is transported up the ramp 22, the rear of vehicle bed 10 is depressed slightly and the cross support 32 engages the ground to assist in supporting the rear of the vehicle bed 10 during unloading or off loading of a vehicle therefrom. Typically, the ramp 22 is formed of heavy gauge steel material and weighs a substantial amount, e.g., on the order of 75-150 pounds. An operator typically grasps the distal end of the ramp 22 to rotate the ramp 22 between the load disposition and the transport disposition. As can be appreciated, the weight of the ramp 22 itself assists in translation of the ramp 22 between the transport disposition and the load disposition, while the ramp 22 must be lifted with considerable effort to rotate the ramp 22 from the load disposition to the transport disposition.

Referring to FIGS. 1-3, one embodiment of the auto latch system of the present invention is shown generally at 40 and has two major components: a latch assembly 42 and a ramp mount 44.

The latch assembly 42 includes a latch bracket 46 having a generally crescent-shaped bracket body 49. The bracket body 49 has an engagement end 50 and an opposed bearing end 52. An orthogonally (or otherwise transversely) disposed handle 54 is mounted to the bracket body 49 of the latch bracket 46 proximate the apex of the engagement end 50. The handle 54 may project from the bracket body 49 a convenient distance for manual grasping, e.g., approximately 4 inches.

A mount slot 56 may be defined in the bracket body 49 proximate the handle 54. In one embodiment, the width dimension of the mount slot 56 is approximately 0.68 inch with the radius of the ends of the mount slot 56 being about 0.34 inch.

A loading disposition surface, such as a load catch 58, may be defined in the exterior margin of the bracket body 49. The load catch 58 may be radiused (or otherwise arcuate) and defined (or otherwise bounded) in part by a lip 59. A transport disposition portion, such as a catch 60, may be displaced from the load catch 58 by a radiused (or otherwise arcuate) ramp 62. The transport catch 60 may be defined by a substantially greater indentation than the load catch 58. In one embodiment, the depth (or otherwise linear) dimension of the transport catch 60 bears a relationship to the length (or otherwise linear) dimension of the mount slot 56. As will be seen, the depth dimension, D, of the transport catch 60 may be less than the length dimension, L, of the mount slot 56.

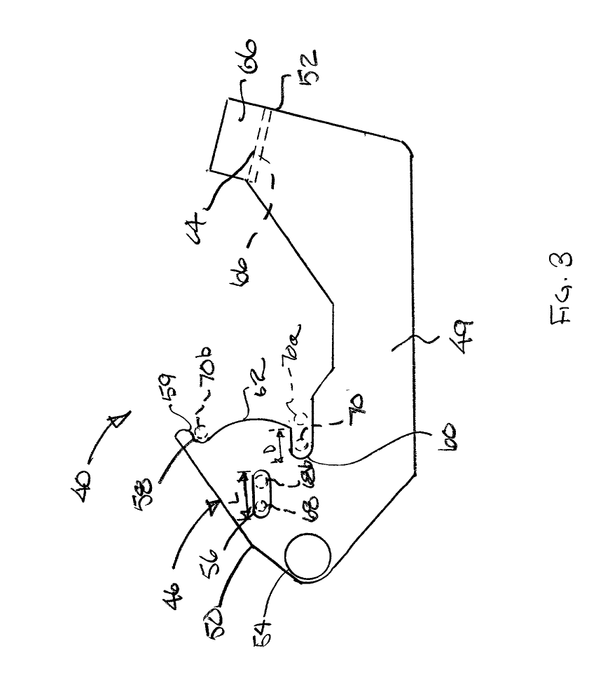

Referring to the bearing end 52 of the bracket body 49, a bearing surface 66 is formed in a generally orthogonal (or otherwise transverse) relationship to the plane of the bracket body 49 by bending along a bend line 64. Once bent, the bearing surface 66 is disposed generally as indicated in phantom in FIG. 3.

In the embodiment depicted herein, the latch mount 48 projects generally orthogonally (or otherwise transversely) to the side of the ramp side rail 24 and includes a threaded stud 68 and a spaced apart stop rod 70. The latch mount 48 includes a cover 72. The cover 72 has bores 74 and 76 defined therein. A lock nut 78 for threaded engagement with the threaded stud 68 may also be included.

In assembly, the mount slot 56 of the latch bracket 46 is positioned over the threaded stud 68 of the latch mount 48. The bore 74 of the cover 72 is then positioned over the threaded stud 68 and the bore 76 is positioned over the stop rod 70. The locknut 78 is tightened on the threaded stud 68 to secure the auto latch system 40 to the ramp blank. When the lock nut 78 is tightened, sufficient play may be left to permit the bracket body 49 to translate relative to the threaded stud 68, the threaded stud 68 being shiftable relative to the bracket body 49 between the position indicated at 68 and the position indicated at 68b.

In operation, when the ramp 22 is in the transport disposition as indicated in FIG. 2, the threaded stud 68 is positioned as indicated by the numeral 68 and the stop rod 70 is positioned within the transport catch 60 as indicated by the numeral 70. In this disposition, the bearing surface 66 of the latch bracket 46 is engaged (e.g., in contact) with the tail board 16, thereby holding the ramp 22 in the depicted generally erect transport disposition.

To transition the ramp 22 from the transport disposition to the load disposition, the operator grasps the distal end of the ramp 22 and pushes the ramp 22 slightly forward to relieve the tension on the latch bracket 46. This causes the ramp 22 to rotate slightly about the rod hinge 36. The operator then grasps the handle 54 and raises the latch bracket 46. Such motion causes the threaded stud 68 to translate to the position indicated at 68b. Simultaneously, the stop rod 70 translates to the position 70a. The ramp 22 may then be rotated rearwardly and the handle 54 released. As the ramp 22 is rotated rearwardly and downwardly, the stop rod 70 rides on the radiused ramp 62 and ultimately engages the load catch 58 as indicated by the position 70b.

To transition the ramp 22 from the load disposition to the transport disposition, the operator merely grasps the distal end of the ramp 22, then raises and rotates the ramp 22 forward. Such action causes the stop rod 70 to again ride across the radiused ramp 62. When the ramp 22 is essentially in the upright transport disposition, as indicated in FIG. 2, the stop rod 70 clears the radiused ramp 62. The force of gravity then causes the latch bracket 49 to drop down, with the threaded stud 68 translating from the position indicated at 68b to the position indicated at 68 and the stop rod 70 simultaneously translating from the positioning indicated at 70a to the position indicated at 70. In such a disposition, the bearing surface 66 is again positioned to bear upon tail board 16 and to hold the ramp 22 in the upright transport disposition principally by the stop rod 70 engaging the latch bracket 49.

Because numerous modifications of this invention may be made without departing from the spirit thereof, the scope of the invention is not to be limited to the embodiments illustrated and described. Rather, the scope of the invention is to be determined by the appended claims and their equivalents.

What is claimed is:

1. A latch system securable to a ramp, the latch system coupled to a transport vehicle and pivotable between a generally upright transport disposition and a loading disposition, the latch system comprising:
a ramp mount attachable to the ramp and including a stud and a stop rod;
a latch assembly attachable to the mount and including a latch assembly bracket defining a mount slot, a generally arcuate surface with a transport portion, a loading surface, and a bearing surface, the slot dimensioned to accommodate the stud, the arcuate surface configured and dimensioned in relation to the slot such that the latch assembly bracket arcuate surface translates relative to the stop rod between the transport portion and the loading surface when the ramp is maneuvered between the transport disposition and the loading disposition.

2. The latch system of claim 1, in which the latch assembly bracket arcuate surface is configured such that the stop rod is disposed in the transport portion by gravity when the ramp is maneuvered to the transport disposition.

3. The latch system of claim 1, in which the latch assembly bracket bearing surface is positioned to contact the transport vehicle to maintain the ramp in the transport disposition.

4. The latch system of claim 1, further comprising a cover with a first bore accommodating the stud and a second bore accommodating the stop rod.

5. The latch system of claim 4, further comprising a fastener securing the cover to the stud.

6. The latch system of claim 5, in which the fastener is a nut threadably securable to the stud.

7. The latch system of claim 1, the latch assembly further comprising a handle extending from the latch assembly bracket.

8. The latch system of claim 1, the latch assembly bracket further comprising a generally planar first portion defining the slot and arcuate surface and a second portion defining the bearing surface, the first portion generally transversely disposed to the second portion.

9. The latch system of claim 1, the latch assembly bracket further defining a lip, the arcuate surface being bounded by the lip proximate the loading surface.

10. The latch system of claim 1, the latch assembly bracket transport mount slot and transport portion each having a linear dimension, the transport portion linear dimension being less than the transport mount slot linear dimension.

11. A transport vehicle, comprising:
a frame;
a bed attached to the frame;
a ramp attached to the frame and pivotable between a loading disposition and a generally upright transport disposition; and
a latch system comprising:
a ramp mount attachable to the ramp and including a stud and a stop rod;
a latch assembly rotatively attachable to the mount and including a latch assembly bracket, the latch assembly bracket defining a mount slot, a generally arcuate surface with a transport portion, a loading surface, and a bearing surface, the mount slot dimensioned to accommodate the stud, the arcuate surface configured and dimensioned in relation to the slot such that the latch assembly bracket arcuate surface translates relative to the stop rod between the transport portion and the loading surface when the ramp is maneuvered between the transport disposition and the loading disposition.

12. The transport vehicle of claim 11, in which the latch assembly bracket arcuate surface is configured such that the stop rod is disposed in the transport portion by gravity when the ramp is maneuvered to the transport disposition.

13. The transport vehicle of claim 11, in which the latch assembly bracket bearing surface is positioned to contact the transport vehicle to maintain the ramp in the transport disposition.

14. The transport vehicle of claim 11, further comprising a cover with a first bore accommodating the stud and a second bore accommodating the stop rod.

15. The transport vehicle of claim 14, further comprising a fastener fastening the cover to the stud.

16. The transport vehicle of claim 15, in which the fastener is a nut threadably securable to the stud.

17. The transport vehicle of claim 11, the latch assembly further comprising a handle extending from the latch assembly bracket.

18. The transport vehicle of claim 11, the latch assembly bracket comprising a generally planar first portion defining the slot and arcuate surface and a second portion defining the bearing surface, the first portion generally transversely disposed to the second portion.

19. The transport vehicle of claim 11, the latch assembly bracket further defining a lip, the arcuate surface being bounded by the lip proximate the loading surface.

20. The transport vehicle of claim 11, the latch assembly bracket transport mount slot and transport portion each having a linear dimension, the transport portion linear dimension being less than the transport mount slot linear dimension.

21. The transport vehicle of claim 11, in which the transport vehicle comprises a trailer.

22. A method of making a transport vehicle, the transport vehicle including a frame, a ramp pivotably mounted to the frame, and a latch system attachable to the ramp and frame, the method comprising:
forming a ramp mount securable to the ramp and comprising a stud and a stop rod; and
forming a latch assembly bracket, the latch assembly bracket defining a mount slot, a generally arcuate surface with a transport portion, a loading surface, and a bearing surface, the slot dimensioned to accommodate the stud, the arcuate surface configured and dimensioned in relation to the slot such that the arcuate surface translates relative to the stop rod between the transport portion and the loading surface when the ramp is maneuvered between a generally upright transport disposition and a loading disposition.

23. The method of claim 22, further comprising attaching the ramp mount to the ramp.

24. The method of claim 23, further comprising attaching the latch assembly bracket to the ramp mount by disposing the ramp mount stud in the latch assembly bracket slot.

25. The method of claim 22, in which the latch assembly bracket is formed such that the stop rod is disposed in the transport portion by gravity with the ramp is maneuvered to the transport disposition.

26. The method of claim 22, in which the latch assembly bracket is formed such that the latch assembly bracket bearing surface contacts the transport vehicle to maintain the ramp in the transport disposition.

27. The method of claim 22, further comprising disposing the stud and the stop rod in a cover.

28. The method of claim 27, further comprising securing a fastener to the stud.

29. The method of claim 28, the fastener comprising a nut and in which securing the fastener to the stud comprises threading the nut to the stud.

30. The method of claim 22, in which forming a latch assembly bracket further comprises extending a handle from the latch assembly bracket.

31. The method of claim 22, in which forming the latch assembly bracket further includes disposing the latch assembly bearing surface generally transversely to a remainder of the latch assembly.
